(19) United States
(12) Patent Application Publication
(10) Pub. No.: US 2016/0295894 A1
(43) Pub. Date: Oct. 13, 2016

(54) FOOD INTOLERANCE PREVENTION SYSTEM AND METHOD

(71) Applicant: Tiffany Brown-Bush, Charlotte, NC (US)

(72) Inventor: Tiffany Brown-Bush, Charlotte, NC (US)

(21) Appl. No.: 15/092,660

(22) Filed: Apr. 7, 2016

Related U.S. Application Data
(60) Provisional application No. 62/144,075, filed on Apr. 7, 2015.

(51) Int. Cl. A23K 1/18

(52) U.S. Cl. CPC A23L 1/293; A23L 1/0073; A23L 1/38; A23L 1/212; A23L 1/32; A23L 1/223; A23L 1/237; A23L 1/2215; A23L 1/2363; A23L 1/362; A23L 1/2121; A23V 2002/00

(57) ABSTRACT

A food intolerance prevention system where the user eats a day 1 bar on the first day, a day 2 bar on the second day, and a day 3 bar on a third day. Wherein each of the three (3) bars, and all 3 bars have different feature proteins and fats.

### RELATED APPLICATIONS

This non-provisional patent application claims priority from provisional patent application filed on 7 Apr. 2016, with application number 62/144,075.

### GOVERNMENT SPONSORSHIP

This invention and inventor did not receive government sponsorship or funds for this invention.

### FIELD OF THE INVENTION

This invention relates to a system and method of eating to prevent or reduce food intolerance.

### BACKGROUND OF THE INVENTION

Many people try to regulate their food, drink, and supplement intake. Some people eat protein bars or energy bars. Energy bars, drinks, and other items fall under the category of sports nutrition. The sports nutrition industry now designs products that allow people to continue to work out and perform at higher intensity for a longer period of time. Energy bars are primarily composed of carbohydrates, with smaller amounts of protein and fat. These all are convenient forms of sugar that digest quickly to provide you with energy. Protein bars are primarily composed of protein, and even fat, with smaller amounts of carbohydrates.

Food intolerance, also known as non-allergic food hypersensitivity, refers to difficulty in digesting certain foods. Food intolerance is different from food allergy.

Unlike a food allergy, which triggers the immune system, food intolerance does not. Foods commonly associated with food intolerance may include grains containing gluten, dairy products, oils, proteins, nuts, nut butters and food that causes gas or bloating, such as beans and cabbage.

Not all negative food reactions are immediate. For example, in some cases foods may cause a delayed or mild negative response.

Some physicians estimate that nearly 60% of people living in the United States have at least one food allergy, intolerance, or sensitivity that is mild, not diagnosed, or hidden.

Many food allergies or food sensitivities may go undetected because they manifest in milder ways, as compared with a major immediate hypersensitivity to an offending food.

Many times the allergy or sensitivity is a result of overexposure to a particular food or nutrient.

Food sensitivities may cause the following symptoms: dark circles under the eyes; fluid retention; headaches; sinus congestion; chronic ear infections; asthma; indigestion; abdominal pain; bloating; gas or general discomfort; fatigue; joint inflammation; joint pain; impaired cognition or foggy head; memory problems; mood swings; anxiety; depression; dermatitis.

There exists a need of limit physiological exposure to prevent the development of a food intolerance, by using a rotation diet.

There exists a need for a system and diet that can reduce or prevent food intolerance.

There is a need for a supplement and program where every need is met under one roof-nutrition, mental health, fitness, and customized supplementation.

There is a need and demand for paleo friendly-vegan appropriate, gluten-dairy-soy-sugar free, prebiotic and digestible fibers, and a deliciously satisfying taste.

Multiple embodiments of the system are disclosed herein. It will be understood that other objects and purposes of the invention, and variations thereof, will be apparent upon reading the following specification and inspecting the accompanying drawings.

### SUMMARY OF THE INVENTION

One aspect of the present invention is a food intolerance prevention system 50, comprising: providing a day 1 bar 70; eating said day 1 bar 70 on a day 1; providing a day 2 bar 80 having ingredients that are not biologically related to the ingredients in the day 1 bar 70; eating said day 2 bar 80 on a day 2; providing a day 3 bar 90 having ingredients that are not biologically related to the ingredients in said day 1 bar 70 and in said day 2 bar 80; and eating said day 3 bar 90 on a day 3.

Another aspect of the present invention is a food intolerance prevention system 50, consisting essentially of the following steps: eating a day 1 bar on day 1 140, eating a day 2 bar on day 2 150, and eating a day 3 bar on day 3 160.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention.

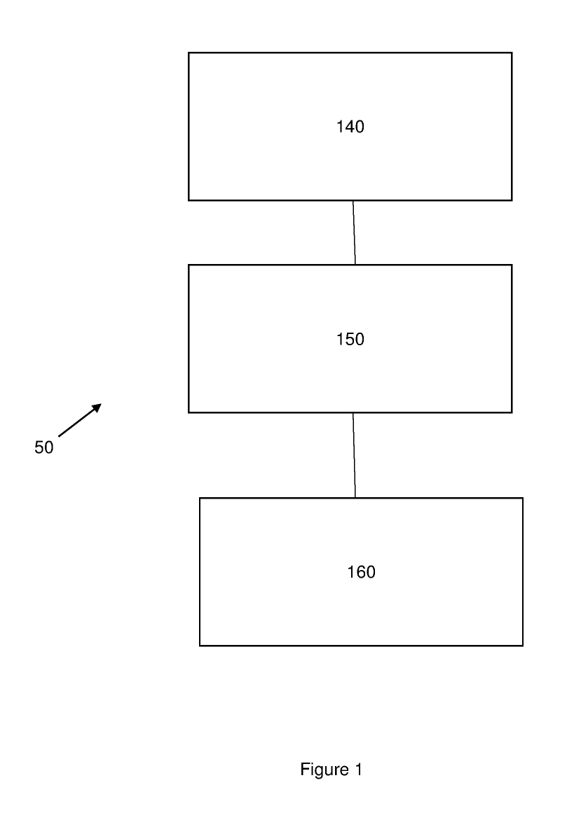

### DETAILED DESCRIPTION

### Reference Numerals List

10 food intolerance
20 easily identifiable ingredients
30 frequency
40 daily basis
50 food intolerance prevention system
60 food rotation
70 day 1 bar
80 day 2 bar
90 day 3 bar
100 day 4 bar
110 identification of different days
120 biologically related foods
130 rotation diet
140 eating a day 1 bar on day 1
150 eating a day 2 bar on day 2
160 eating a day 3 bar on day 3

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words.

The present invention 10 is a new convenient snack or meal replacement solution that is the perfect high-quality refuel for busy people on the go. The present invention is the first “Paleo-Vegan rotation” type protein bar that are free of preservatives and toxins, include minimal ingredient and are super tasty. The present invention 10 is a three-day rotation system that proactively prevents over exposing the body to the same protein and fats, which causes food-intolerance and weight loss resistance. The present invention 10 bars are made with all natural, non-allergen supplements which reduces or eliminates weight loss resistance, digestive, sinus and skin issues. The bars 10 are sugar free, reducing cravings, emotional struggles, and inflammation.

One embodiment of the present invention may be a bar or protein bar 10 that may contain all natural easily identifiable ingredients 20.

Another embodiment allows the consumer to eat the bars 10 safely on a certain frequency 30. In one embodiment the frequency 30 is a daily basis 40.

The food intolerance prevention system 50 may use the method of food rotation 60. One method of food rotation 60 may feature proteins and fats that are unique to the previous day. A day in this food rotation system 60 is twenty-four (24) hours. For example, there may be a day 1 bar 70, a day 2 bar 80, day 3 bar 90, and a day 4 bar 100. Other day bars may be used, such as 5th to 365 day bars.

Inventor: Tiffany Brown-Bush Non-Provisional Patent Application

In another embodiment, one method of food rotation 60 may feature proteins and fats that are unique to the previous two days. For example, the day 1 bar, day 2 bar, and day 3 bar may have feature proteins and fats that are unique to each other, so all 3 bars have different feature proteins and fats.

The identification of different days 110 informs the user which bar to eat. Consuming bars 10 using the method of food rotation 60 reduces or eliminated food tolerance prevention 50.

One method of food rotation 60 may be eating biologically related foods 120 on one day, then waiting about 3 to 4 days before eating the same biologically related foods 120.

For example, oats may be one type of the biologically related food 120. The user may eat oats on Sunday for breakfast at about 9:00 AM. Depending on the exact version of rotation diet 130, the user may eat oats once in the day, or more than once in the same day, which terminates at 9:00 AM the next Monday. After that day, oats would not be eaten again until Thursday between 9:00 AM and terminating on Friday at 9:00 AM.

One result from using the rotation diet 130 is prevention or reduction of food intolerance, foot sensitivities, or food allergies.

In one embodiment there are three different bars:

(1) Vanilla Cashew Delight is made with Cashew Butter, Pea protein powder, Vanilla Extract, Stevia and Cashew nuts for extra Delight. This blend makes up the protein bar for Day 1 of the designated 3-day intolerance rotation system; this may be referred to as a day 1 bar.

(2) Chocolate Coco-Dream is made with Sunflower Seed Butter, Coconut Flakes, Rice protein powder, Sea Salt and Happy Dreams. This blend makes up the protein bar for Day 2 of the designated 3-day rotation system; this may be referred to as a day 2 bar; and

(3) Apple Butter Bliss is made with Almond Butter, Apples, Egg Protein, Sea Salt, Stevia and Bliss; this may be referred to as a day 3 bar.

In one embodiment the day 1, day 2, and day 3 bars may be interchangeable, so long as the rotation is followed.

The day 1 bar may be ingested on day 1, day 2 indicates that this is the day after day 1, day 3 indicates this is the second day after day 1, and so forth.

In one embodiment the day 1 bar may have the following ingredients; organic rice protein, sunflower seed butter, prebiotic fiber, chicory root fiber, organic coconut, organic cocoa, organic cacao nibs, organic coconut oil, sea salt, and stevia.

In one embodiment the day 2 bar may have the following ingredients; organic almond butter, chicory root fiber, egg white protein, almonds, apples, prebiotic fiber, cinnamon, Himalayan pink salt, and stevia.

In one embodiment the day 3 bar may have the following ingredients: organic cashew butter, pea protein, chicory root fiber, prebiotic fiber, organic cashews, organic vanilla extract, cinnamon, sea salt, and stevia.

In use, the system may have the following steps: eating a day 1 bar on day 1 140, eating a day 2 bar on day 2 150, and eating a day 3 bar on day 3 160, then eating a day 1 bar on day 4, eating a day 2 bar on day 5, eating a day 3 bar on day 6, then eating a day 1 bar again on day 7.

Although particular preferred embodiments of the invention have been discussed in detail for illustrative purposes, it will be recognized that variations or modifications of the disclosed apparatus, including the rearrangement of parts, lie within the scope of the present invention.

I claim:

1. A food intolerance prevention system (50), consisting:
providing a day 1 bar (70);
eating said day 1 bar (70) on a day 1;
providing a day 2 bar (80) having ingredients that are not biologically related to the ingredients in the day 1 bar (70);
eating said day 2 bar (80) on a day 2;
providing a day 3 bar (90) having ingredients that are not biologically related to the ingredients in said day 1 bar (70) and in said day 2 bar (80); and
eating said day 3 bar (90) on a day 3.

2. The system of claim 1, further comprising:
eating said day 1 bar (70) on a day 4.

3. The system of claim 1, further comprising:
eating a day 4 bar on a day 4.

4. The system of claim 1, further comprising:
eating a day 1 bar on a day 4.

5. The system of claim 1, wherein said day 1 bar consists essentially: organic rice protein, sunflower seed butter, prebiotic fiber, chicory root fiber, organic coconut, organic cocoa, organic cacao nibs, organic coconut oil, sea salt, and stevia.

6. The system of claim 1, wherein said day 2 bar consists essentially of: organic almond butter, chicory root fiber, egg white protein, almonds, apples, prebiotic fiber, cinnamon, Himalayan pink salt, and stevia.

7. The system of claim 1, wherein said day 3 bar consists essentially of: organic cashew butter, pea protein, chicory root fiber, prebiotic fiber, organic cashews, organic vanilla extract, cinnamon, sea salt, and stevia.

8. The system of claim 1, wherein said day 1 bar consists essentially of: cashew butter, pea protein powder, vanilla extract, stevia and cashew nuts for extra delight.

9. The system of claim 1, wherein said day 2 bar consists essentially of: sunflower seed butter, coconut flakes, rice protein powder, sea salt and happy dreams.

10. The system of claim 1, wherein said day 3 bar consists essentially of: apple butter bliss is made with almond butter, apples, egg protein, sea salt, stevia and bliss.

11. A food intolerance prevention system (50), consisting essentially of the following steps: eating a day 1 bar on day 1 (140), eating a day 2 bar on day 2 (150), and eating a day 3 bar on day 3 (160).

12. , The food intolerance prevention system (50) of claim 11, further consisting essentially of: eating a day 1 bar on day 4, eating a day 2 bar on day 5, eating a day 3 bar on day 6, then eating a day 1 bar again on day 7.
